(19) United States
(12) Patent Application Publication
(10) Pub. No.: US 2007/0024744 A1
(43) Pub. Date: Feb. 1, 2007

(54) System and method for periodic reset of a display

(76) Inventors: John W. Kaehler, Lake Bluff, IL (US); Ken K. Foo, Gurnee, IL (US)

Correspondence Address: MOTOROLA INC, 600 NORTH US HIGHWAY 45, ROOM AS437, LIBERTYVILLE, IL, 60048-5343, US

(21) Appl. No.: 11/189,484

(22) Filed: Jul. 26, 2005

(51) Int. Cl. H04N 7/01; H04N 11/20

(52) U.S. Cl. 348/448; 348/441

(57) ABSTRACT

An electronic device having a video circuit for driving a display (100), the video circuit comprising one or more working registers (240) and a reset circuit (220, 230). The working register or registers (240) store video parameters of the display (100) and, optionally, the video circuit may be associated with one or more video synchronization signal (210). The reset circuit (220, 230) receives a periodic signal, such as the video synchronization signal or signals (210), and provides predetermined video parameters to the working register or registers (240) of the video circuit in response to receiving the periodic signal.

### FIELD OF THE INVENTION

The present invention relates generally to the field of video circuitry of an electronic device and, more particularly, to circuitry for resetting working registers of the video circuitry of the electronic device.

### BACKGROUND OF THE INVENTION

Due to the complexity of environmental conditions, a display driver integrated circuit (“IC”) of an electronic device may enter a variety of defective states that may cause defective mode entry. For example, the IC may enter a defective state due to supply voltage drops, spikes, electrostatic discharge, or other external causes. In many cases, the electronic device may overcome the defective state and return to proper operation of its display by resetting, or reinitializing, the IC.

Typically, error recovery is achieved using software, which is quite cumbersome. Software is written and maintained to correctly detect error conditions and, then correctly recover, which is quite difficult to achieve via software. Most electronic devices have no way of knowing whether a problem exists, so reset lines are of little practical use.

There is a need for a system and method for error recovery from a defective state of a display that operates with existing hardware and software of electronic devices. The error recovery should be performed autonomously and reliably to minimize any burdens upon users, and have minimal power impact on the device.

### BRIEF DESCRIPTION OF THE DRAWINGS

FIG. 1 is a diagrammatic view illustrating an exemplary display in accordance with the present invention.

FIG. 2 is a block diagram illustrating select, exemplary components of the reset and video circuits in accordance with the present invention.

FIG. 3 is a block diagram representing an exemplary embodiment of the counter circuit of FIG. 2.

FIG. 4 is a flow diagram representing an exemplary embodiment of an operation of the reset circuit in accordance with the present invention.

### DETAILED DESCRIPTION OF THE PREFERRED EMBODIMENTS

The present invention is a system and method for ensuring reset to the correct operating conditions of an electronic device regardless of the current operating state of the display of the device. Due to the universal approach of the system and method, they may also cover possible failures presently unknown. In particular, the system and method are directed to an internal reset that may be clocked on a periodic basis so that the display of an electronic device may operate properly. For example, the display driver may have a synchronization signal, and a counter circuit may be driven from this signal to reset the display periodically.

The display driver may be a “dumb” display driver that does not include an internal memory and must be given display data and control signals in real-time. However, it is to be understood that the present invention is not limited to “dumb” display drivers and may also be applied to other types of drivers, such as “smart” display drivers with internal memory.

One aspect of the present invention is an electronic device having a video circuit for driving a display, the video circuit comprising one or more working registers and a reset circuit. The working register or registers store video parameters of the display. The reset circuit provides predetermined video parameters to the working register or registers of the video circuit in response to receiving a periodic signal. In particular, the video circuit may be associated with one or more video synchronization signals, and the reset circuit may provide the predetermined video parameters to the working register or registers of the video circuit after each occurrence of receiving the video synchronization signal or signals.

Another aspect of the present invention is a method of the electronic device. A periodic signal is received, and predetermined video parameters are provided to the one or more working registers of the video circuit in response to receiving the periodic signal. In particular, the video synchronization signal or signals associated with the video circuit may be received. The predetermined video parameters may then be provided to the working register or registers of the video circuit after each occurrence of receiving the video synchronization signal or signals.

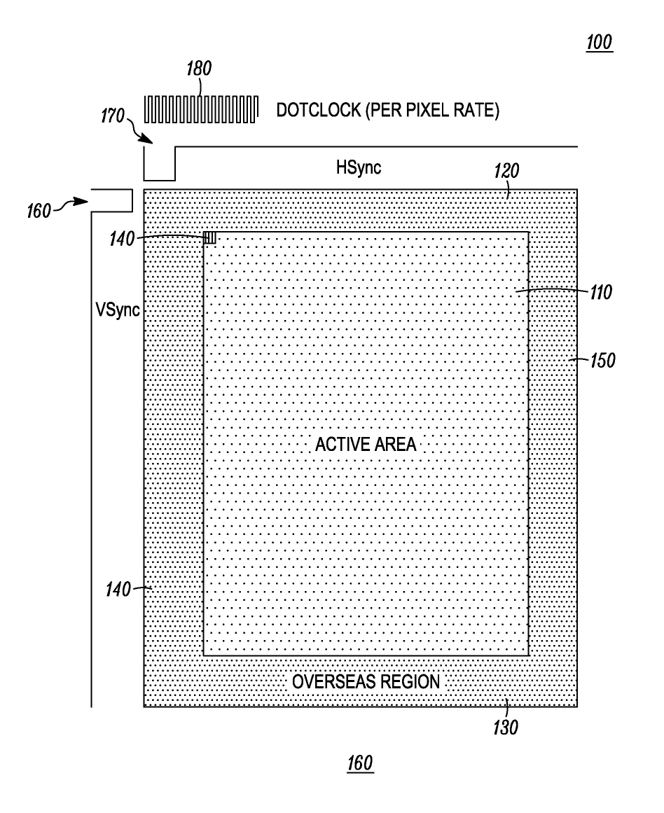

Referring to FIG. 1, this diagram illustrates the relationship of the Horizontal Sync pulse and Vertical Sync pulse to a display 100 of an electronic device. The display 100 includes an active area 110 and may also include an overscan region that includes an upper overscan region 120, a lower overscan region 130, a left overscan region 140 and/or a right overscan region 150. For example, as shown in FIG. 1, the overscan region 120, 130, 140, 150 surrounds the active region 110. For the embodiment shown in FIG. 1, the raster of the display 100 scans from top-to-bottom and left-to-right. The reset operation of the present invention may occur when the raster is in one of the overscan regions 120, 130, 140, 150. In doing so, this embodiment has the advantage using a reset operation that is not a viewable event, particularly when it is not required. Also, for this embodiment, reset would occur when both pulses are low, as represented by the vertical synchronization signal 160 and horizontal synchronization signal 170, so the raster would be positioned at the upper left hand area of the overscan regions 120, 130, 140, 150. It should be noted that, for another embodiment, the display driver may have inverted logic for the vertical synchronization signal 160 and horizontal synchronization signal 170.

Internal loading of the working registers may be clocked using a Dotclock signal 180 of the display 100. In FIG. 1, the relationship between the vertical synchronization signal 160, the horizontal synchronization signal 170, and the Pixel clock or Dotclock signal 180. All three signals may have a fixed relationship and based ultimately on the Dotclock signal 180.

For example, the vertical synchronization signal 160 may have a frequency that is about 60 Hz. but may be more or less dependent on the application or operating mode. Switching to 30 Hz. may save power, or boosting to 120 Hz. may improve performance (such as motion blur characteristics). Also, slightly higher frequencies (for example, 65 to 70 Hz.) may be used to minimize performance degradation due to flicker. Also, the horizontal synchronization signal 170 may have a frequency that is based upon the number of rows in the display 100 (vertical number of pixels plus several rows of the upper and lower overscan regions 120, 130. An example would be, for a quarter VGA (240 wide by 320 high), the horizontal synchronization signal may have a frequency of (320+6)*60 Hz=19,560 Hz where 6 is a typical vertical overscan. Further, the Dotclock signal 180 may have a frequency that is based upon the number of columns plus the left and right overscan regions 140, 150 multiplied by the number of rows plus upper and lower overscan regions 120, 130 multiplied by the desired frame frequency, i.e., for quarter VGA (240+40)×(320+6)×60 Hz=5.4768 MHz where 40 is a typical horizontal overscan.

For a periodic reset in accordance with the present invention, it is desirable to have the reset operation occur at a time where it is not visible to an end user of the display 100. Therefore, the reset circuit may be periodic, synchronized with the display 100, and occur during the overscan region 120, 130, 140, 150. It should be noted that the reset may solely use the vertical synchronization signal 160 and reset every frame, for example, the negative going edge of the vertical synchronization signal may trigger the reset; however, that capability is not required (resetting the display 60 times a second) and would have an impact on power consumption. For one embodiment, the reset operation may occur about once per second.

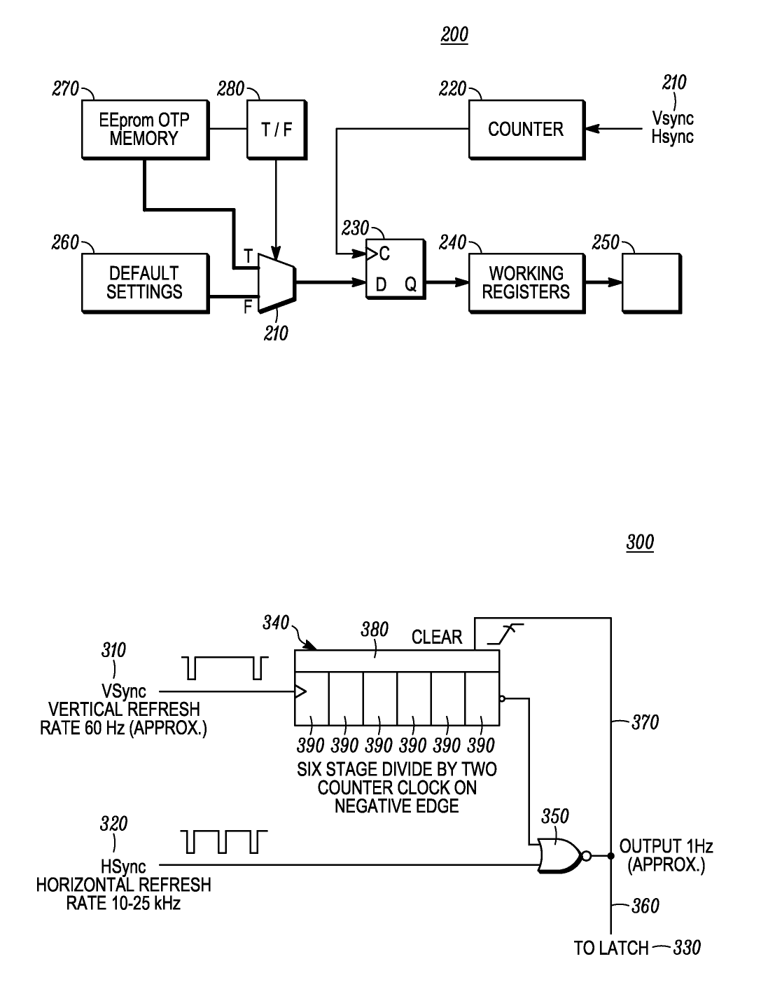

Referring to FIG. 2, there is shown a block diagram 200 illustrating the reset circuit and associated components in accordance with the present invention. The reset circuit generates a periodic signal to cause each reset of the display 100. Although reset may be actuated by a counter in response to an external signal, as described below, it is to be understood that this function may be actuated by a variety of periodic signal generators and should not be restricted to this particular embodiment of the counter. For example, other methods for generating a periodic signal include timers, such as an analog 555 timer using RC decay time to generate the periodic signal.

For one embodiment, the reset circuit may receive a synchronization signal 210, such as a vertical synchronization signal, a horizontal synchronization signal or both signals. The reset circuit may include a counter circuit 220 for determining a desired frequency to be provided to a latch 230, based on the synchronization signal 210, for resetting working registers 240 of the video circuitry of the electronic device. For example, the vertical and horizontal synchronization signals 160, 170 may have frequency of about 60 Hz. and 19.5 kHz. respectively, but it may be desirable to reset the working registers of the video circuitry at a much slower rate, such as once per second. An exemplary counter circuit 220 is described in detailed, below and, for one embodiment, the latch 230 may be a flip-flop or latch, such as a data latch (“D latch”) as shown in FIG. 2. Information stored in the working registers 240 may be provided to other components 250 of the device for the purpose of controlling and/or monitoring the display 100.

The block diagram 200 also illustrates one or more memory locations where video parameters may be stored. Default settings memory 260 may include hard-coded default settings for the working registers 240 that are predetermined when the display driver IC is manufactured. If more than one setting is stored in memory, programmable memory, such EEPROM or one-time programmable (OTP) 270, may include settings for the working registers 240 that are predetermined when the display driver IC is assembled in an electronic device along with its associated display. The working register information may be distributed throughout the video driver IC affecting the overall operational characteristics of the electronic device. Where multiple settings are stored in memory, the components of the display 100 may include a flag 280 coupled to a multiplexer 210 for determining which setting should be provided to the latch 230 and, thus, be used to reset the working registers 240. For one embodiment, as shown in FIG. 2, the default settings of the default settings memory 260 are provided to the working registers 240 if the flag 280 is “false”, whereas the programmed settings of the programmable memory 270 are provided to the working registers if the flag is “true”.

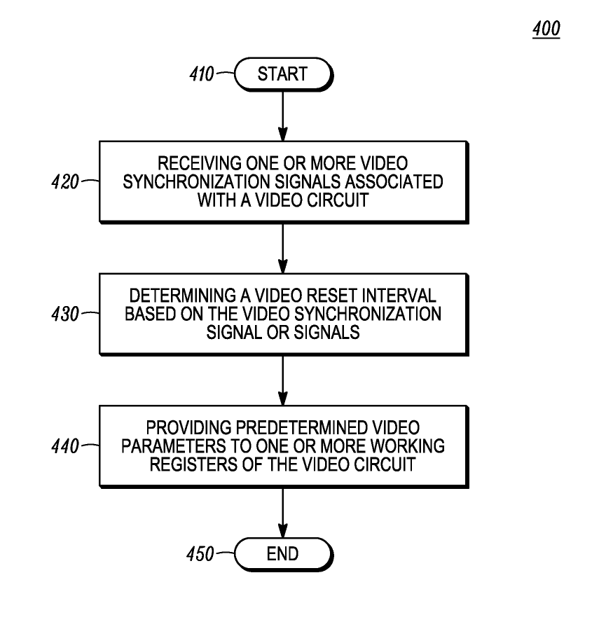

Referring to FIG. 3, there is shown an exemplary counter circuit 300 for determining the timing for resetting the display 100 based on a vertical synchronization signal 310, a horizontal synchronization signal 320, or both. The output of the exemplary counter circuit 300 is provided to the latch 230, shown in FIG. 2. Where the six-stage counter 340 receives both vertical and horizontal synchronization signals 310, 320, a NOR gate 350 is used to identify a period when both signals are “low”, to ensure that the display 100 is reset while the video circuit is scanning in an overscan region of the display. The output of the NOR gate 350 is forwarded along one path 360 to the output 330 of the exemplary counter circuit 300 and fed back, along another path 370, to a second input 380 of the six-stage counter 340 to clear all stages 390 of the six-stage counter. Thus, when the reset signal is asserted, it also has the dual function of clearing the binary counter which has the effect of starting the six-stage counter 340 over again.

For the embodiment shown in FIG. 3, the six-stage counter 340 is a six stage divide by two binary counter with an input clocking on the negative going edge. The least significant bit corresponds to the left-most stage of the six stages 390 where the vertical synchronization signal 310 is received. After processing the vertical synchronization signals 310 through the six stages 390 (assuming that the stages were clear before processing), we would have an output transition, i.e., the output is inverted to reflect a High-to-Low transition. Since this transition is logically NOR'd and was High during this counting, the output 370 of the NOR gate 350 was low during this process regardless of horizontal synchronization signal 320. When the horizontal synchronization signal 320 is low at the same time as the other NOR input, then the reset signal coming out of the NOR gate 350 may go high. For this embodiment, the reset signal pulse has a similar duration to the horizontal synchronization signal 320 or less depending on propagation delay of counter clear.

For the embodiment shown in FIG. 3, the six-stage counter 340 may reset the display 100 about once a second for a vertical synchronization signal that is about 60 Hz. The actual frequency may be slightly higher than 60 Hz. to avoid interference with AC lighting. Also, the six-stage counter 340 has the effect of slowing down an incoming signal to 1/64th of its original frequency. Thus, for this embodiment, the counter circuit 300 has the effect of generating a 1 Hz. signal from a synchronization signal that is about 64 Hz.

Referring to FIG. 4, there is shown a flow diagram representing an exemplary embodiment of an operation 400 of the reset circuit. Starting at step 410, the reset circuit receives one or more video synchronization signals associated with a video circuit at step 420. The synchronization signals may include one or both of a vertical synchronization signal and a horizontal synchronization signal. The operation 400 then determines a video reset interval based on the video synchronization signal or signals at step 430. For example, the counter circuit 300 may generate the reset signal at a frequency that is a fraction of the frequency of the synchronization signal. Next, the operation 400 provides predetermined video parameters, stored in memory as default or programmed settings, to one or more working registers of the video circuit at step 440. Thereafter, the operation 400 terminates at step 450.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. An electronic device having a video circuit for driving a display, the video circuit comprising:
at least one working register for storing video parameters of the display; and
a reset circuit configured to provide predetermined video parameters to the at least one working register of the video circuit in response to receiving a periodic signal.

2. The device of claim 1, wherein:
the video circuit is associated with at least one video synchronization signal; and
the reset circuit is configured to receive the at least one video synchronization signal and to provide the predetermined video parameters to the at least one working register of the video circuit after each occurrence of receiving the at least one video synchronization signal.

3. The electronic device of claim 2, wherein the at least one video synchronization signal associated with the video circuit includes a vertical synchronization signal.

4. The electronic device of claim 2, wherein the at least one video synchronization signal associated with the video circuit includes a horizontal synchronization signal.

5. The electronic device of claim 2, wherein the reset circuit comprises:
a counter circuit configured to receive the at least one video synchronization signal and to generate a reset signal based on the at least one video synchronization signal; and
a latch configured to provide the predetermined video parameters to the at least one working register in response to the reset signal.

6. The electronic device of claim 1, further comprising a multiplexer configured to identify a particular video parameter among a plurality of video parameters associated with the video circuit.

7. The electronic device of claim 1, wherein the display is reset while the video circuit is scanning in an overscan region of the display.

8. A method of an electronic device having a video circuit for driving a display, the video circuit including at least one working register for storing video parameters of the display, the method comprising:
receiving a periodic signal; and
providing predetermined video parameters to the at least one working register of the video circuit in response to receiving the periodic signal.

9. The method of claim 8, wherein:
receiving a periodic signal includes receiving at least one video synchronization signal associated with the video circuit; and
providing predetermined video parameters to the at least one working register of the video circuit includes providing the predetermined video parameters to the at least one working register of the video circuit after each occurrence of receiving the at least one video synchronization signal.

10. The method of claim 9, wherein receiving at least one video synchronization signal associated with the video circuit includes receiving a vertical synchronization signal.

11. The method of claim 9, wherein receiving at least one video synchronization signal associated with the video circuit includes receiving a horizontal synchronization signal.

12. The method of claim 9, further comprising generating a reset signal based on the at least one video synchronization signal, wherein providing predetermined video parameters to the at least one working register of the video circuit includes providing the predetermined video parameters to the at least one working register in response to the reset signal.

13. The method of claim 8, further comprising identifying a particular video parameter among a plurality of video parameters associated with the video circuit.

14. The method of claim 8, further comprising resetting the display while scanning in an overscan region of the display.
